(19) United States
(12) Patent Application Publication
(10) Pub. No.: US 2008/0176430 A1
(43) Pub. Date: Jul. 24, 2008

(54) Electrical connector assembly

(75) Inventors: Wei Yuan, ShenZhen (CN); Yu-San Hsiao, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/009,689

(22) Filed: Jan. 22, 2008

(30) Foreign Application Priority Data
Jan. 22, 2007 (CN) 200720033806.9

(51) Int. Cl. H01R 4/66

(52) U.S. Cl. 439/101

(57) ABSTRACT

An electrical connector assembly comprises a cable end first connector and a board end second connector engaging with said first connector. Said second connector comprises a dielectric housing defining a first end face, a second end face in opposite side of said first end face, a pair of opposite side walls perpendicular to said second end face. Each of said side walls has a top panel perpendicularly extending out from the inner top edge thereof; a pair of second grounding contacts respectively received in the housing, one end of each of said second grounding contacts exposed for electrically connecting the grounding circuit of a printed circuit board, another end of each of said second grounding contacts partially exposed on the lower surface of said top panel.

### BACKGROUND OF THE INVENTION

1. Field of the Invention

The present invention relates to an electrical connector assembly.

2. Description of Related Art

Serial Advanced Technology Attachment (Serial ATA) connectors in accordance with Serial ATA specification are widely used in desktop computers for transmitting signals from motherboard to HDD or transmitting power from power supply of the computer to the HDD, or transmitting signals or power between outer HDD to the computer. With the developing of digital consumer electronic, the Serial ATA connectors is not only used in computer and network, but also used in DVD player, home server, multi-media center and TV game set, etc. In order to meet the wider and wider usage of serial ATA interface, more and more requirements of the serial ATA connectors are needed; for example, for having no electrostatic discharge protection, a serial ATA connector will collect a great amount of static electricity when it is used for long time, then the connector will adsorb dust even produce electrostatic discharge. The dust may result in mechanical damage to the electronic components with which the connector is electrically coupled and the discharge of static electricity may result in electrical damage to the electronic components with which the connector is electrically coupled.

In order to avoid such problems, an improved connector assembly is required.

### SUMMARY OF THE INVENTION

An object of the present invention is to provide a connector assembly with electrostatic discharge protection.

Accordingly, to achieve above-mentioned object, an electrical connector assembly comprises a cable end first connector housing a plurality of first contacts and a board end second connector for engaging with said first connector. Said second connector comprises a dielectric housing, said dielectric housing defines a first end face, a second end face in opposite side of said first end face, a tongue board stick out the middle portion of said second end face, a plurality of receiving passages extending onto a side of the tongue board through said first end face and said second end face, a pair of opposite side walls perpendicular to said second end face, each of said side walls has a top panel perpendicularly extending out from the inner top edge thereof; a plurality of second signal contacts are respectively received in said receiving passage of said dielectric housing; a pair of second grounding contacts are respectively secured in the housing, one end of each of said second grounding contacts exposed for electrically connecting the grounding circuit of a printed circuit board, another end of each of said second grounding contacts partially exposed on the lower surface of said top panel for electrically connecting corresponding said first contact.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a exploded, perspective view of an electrical connector assembly of the present invention;

FIG. 2 is a perspective, assembled view of the electrical connector assembly of the present invention;

FIG. 3 is a perspective, assembled view of a dielectric housing of the second connector of the electrical connector assembly of the present invention;

FIG. 4 is a view similar to FIG. 3, but taken from another aspect;

FIG. 5 is a perspective view of the first connector mating with the second connector; and

FIG. 6 is a view similar to FIG. 5, but taken from another aspect.

### DETAILED DESCRIPTION OF THE INVENTION

Reference will now be made in detail to the preferred embodiment of the present invention.

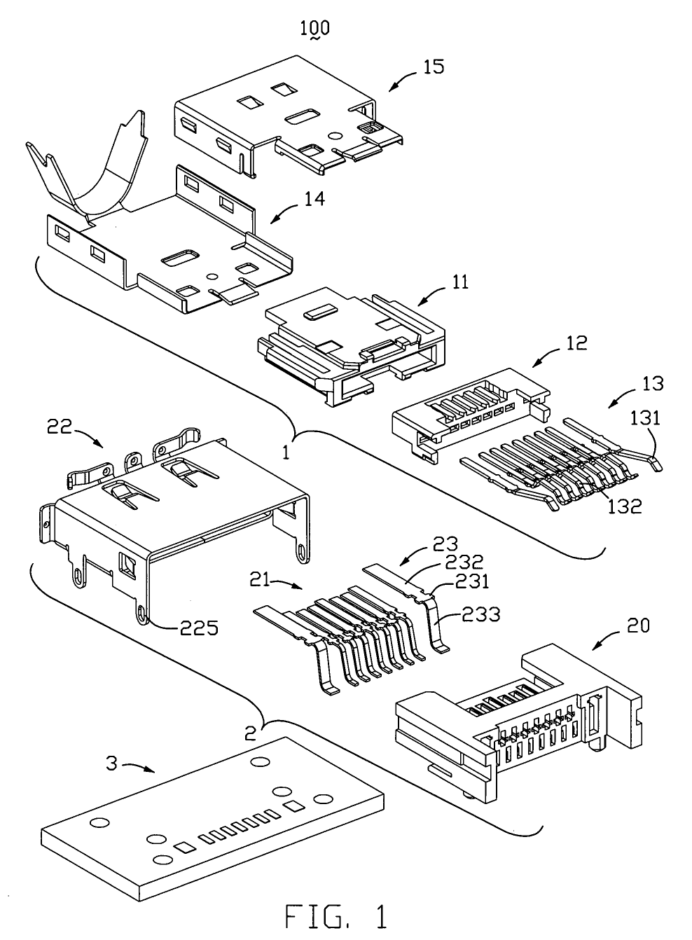

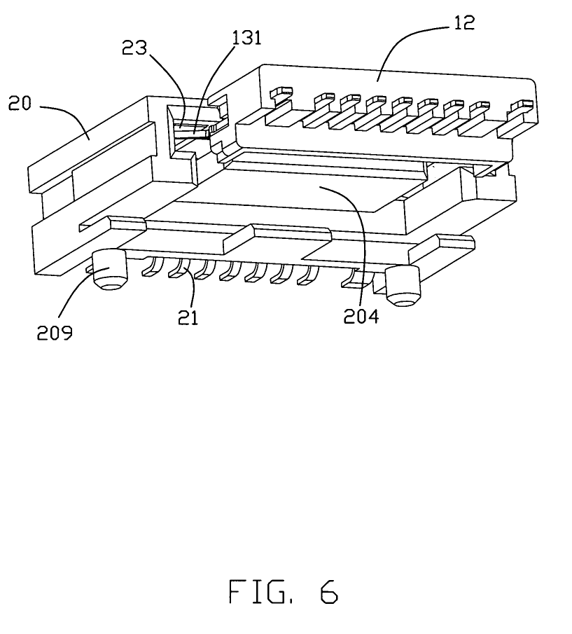

Referring to FIGS. 1-6, the electrical connector assembly 100 comprises a cable end first connector 1 and a board end second connector 2 engaging with the first connector 1.

Referring to FIG. 1, the cable end first connector 1 comprises a contact spacer 12, a plurality of first contacts 13 secured in the contact spacer 12, a base 11 for housing the contact spacer 12, a lower shield 14 covering the lower portion of the base 11, and a upper shield 15 covering the upper portion of the base 11. The first contacts 13 comprises a pair of first grounding contact 131 for contacting with the corresponding second grounding contacts 23 of the second connector 2 and a plurality of first signal contacts 132 for contacting with the corresponding second signal contacts 21 of the second connector 2.

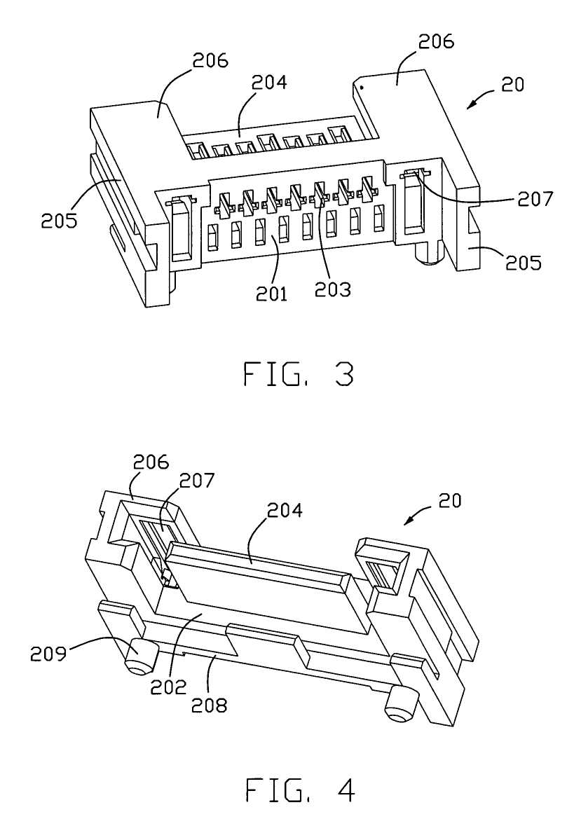

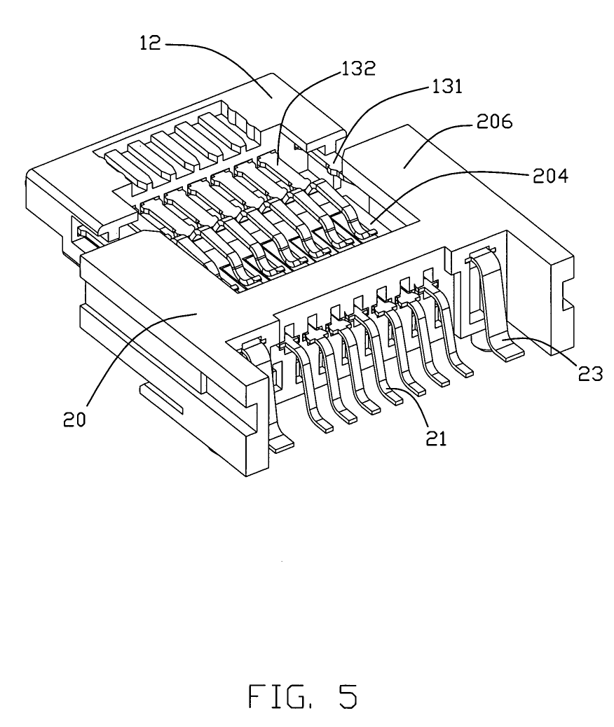

Referring to FIGS. 1-6, the second connector 2 comprises a dielectric housing 20, a plurality of second signal contacts 21, a pair of second grounding contacts 23 respectively received in the dielectric housing 20 and a second shield 22 surrounding the dielectric housing 20. Referring to FIGS. 3-4, the dielectric housing 20 defines a first end face 201, a second end face 202 in opposite side of the first end face 201, a tongue board 204 sticking out the middle portion of the second end face 202, a plurality of receiving passages 203 extending onto a side of the tongue board 204 through the first end face 201 and the second end face 202, a mounting surface 208 for mounting to the printed circuit board 3, two locating post 209 formed on the mounting surface 208 for correctly position the second connector 2 on the printed circuit board 3 and a pair of opposite side walls 205 perpendicular to the end face 201, 202, each of said side walls 205 has a top panel 206 perpendicularly extending out from the inner top edge thereof. A pair of grounding receiving passages 207 extend onto the lower side of each top panel 206.

The second signal contacts 21 are received in the receiving passages 203 respectively, the second grounding contacts 23 are received in the grounding receiving passages 207 respectively, each second grounding contact 23 comprises a flat contacting portion 232 for contacting the corresponding mating cable end first connector 1, a retaining portion 231 for retaining itself in the grounding receiving passage 207 of the dielectric housing 20 and a connecting portion 233 for electrically connecting to the grounding circuit trace on the printed circuit board 3.

The second shield 22 is a metal shell stamped and formed of conductive sheet metal material, The second shield 22 is defined by a top wall 221 and a pair of side wall 222 connected with the top wall 221. A plurality of fastening tabs 223 project downwardly from the top wall 221 for latching the corresponding mating cable end first connector 1. A pair of securing means 224 on two opposite side walls 222 for securing the second shield 22 on the dielectric housing 20. There are four mounting legs 225 on the lower edge of the side walls 222 for electrically connecting to the grounding circuit trace on the printed circuit board 3 and securing the connector 2 on the printed circuit board 3.

In assembly, the second signal contacts 21 is inserted into the receiving passage 203, the second grounding contacts 23 is inserted into the grounding receiving passage 207, the second shield 22 is assembled onto the housing and is secured with the securing means 224, then correctly position the second connector 2 on the printed circuit board 3 with the help of the locating post 209, electrically solder the second grounding contacts 23, the second signal contacts 21, and the mounting legs 225 on the printed circuit board 3.

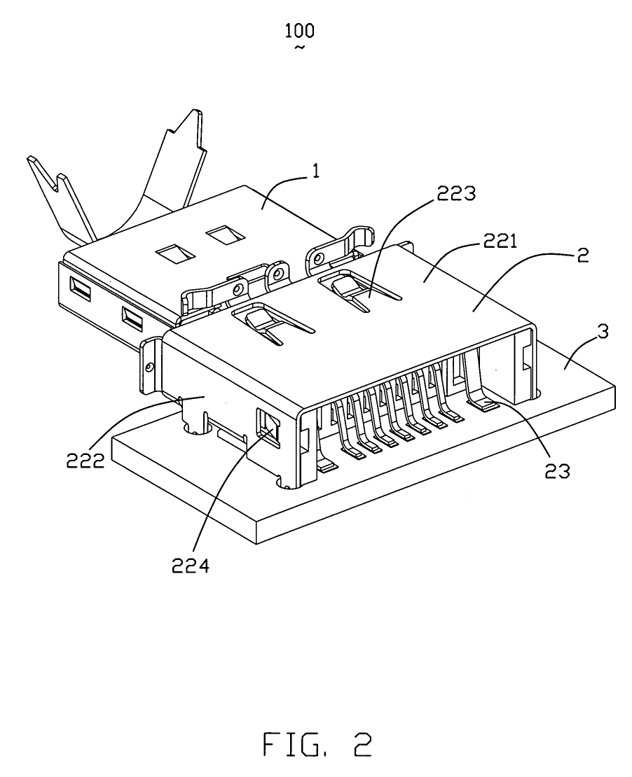

Referring to FIGS. 2, 5, 6, when the cable end first connector 1 is engaged with the board end second connector 2, the first grounding contacts 131 is electrically connected with the second grounding contacts 23, the first signal contacts 132 is electrically connected with the second signal contacts 21, the shields 14, 15 of the first connector 1 is locked with the second shell 22 by the means of fastening tabs 223. Thus, the grounding circuit of the two connectors 1, 2 is electrically connected each other, there is no highly electrostatic charging part in the electrical connector assembly 100, the connectors 1, 2 will not adsorb dust, and the electrical damage caused by the discharge of static electricity is prevented.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector assembly comprising a cable end first connector and a board end second connector for engaging with said first connector, wherein said first connector housing a plurality of first contacts and said second connector comprising:
a dielectric housing defining a first end face, a second end face in opposite side of said first end face, a tongue board stick out the middle portion of said second end face, a plurality of receiving passages extending onto a side of the tongue board through said first end face and said second end face, a pair of opposite side walls perpendicularly extending out from said second end face, each of said side walls has a top panel perpendicularly extending out from the inner top edge thereof;
a plurality of second signal contacts respectively received in said receiving passage of said dielectric housing;
a pair of second grounding contacts respectively secured in the housing, one end of each of said second grounding contacts exposed for electrically connecting the grounding circuit of a printed circuit board, another end of each of said second grounding contacts partially exposed on the lower surface of said top panel for electrically connecting corresponding said first contact.

2. The electrical connector assembly as described in claim 1, wherein said first contacts comprises a pair of first grounding contacts for contacting with the corresponding second grounding contacts of the second connector and a plurality of first signal contacts disposed between said pair of first grounding contacts.

3. The electrical connector assembly as described in claim 2, wherein said first connector further includes a contact spacer securing said plurality of first contacts and a base housing the contact spacer.

4. The electrical connector assembly as described in claim 3, wherein said first connector further includes a lower shield covering the lower portion of the base and a upper shield covering the upper portion of the base.

5. The electrical connector assembly as described in claim 2, wherein a grounding receiving passage defined on the lower surface of each said top panel, said pair of second grounding contacts are received in said grounding receiving passage respectively.

6. The electrical connector assembly as described in claim 5, wherein said second connector further includes a second shield surrounding said dielectric housing.

7. The electrical connector assembly as described in claim 6, wherein said second shield is a metal shell stamped and formed of conductive sheet metal material, which is defined by a top wall and a pair of side wall connected with the top wall; a pair of securing means on two opposite side walls for securing the second shield on said dielectric housing.

8. The electrical connector assembly as described in claim 7, wherein said second shield further defines a plurality of fastening tabs project downwardly from the top wall for latching the corresponding mating cable end first connector.

9. The electrical connector assembly as described in claim 8, wherein said second shield further defines four mounting legs on the lower edge of said side walls for electrically connecting to the grounding circuit trace on the printed circuit board and securing the connector on the printed circuit board.

10. The electrical connector assembly as described in claim 9, wherein said second connector further defines a mounting surface and two locating post on the mounting surface.

11. An electrical connector comprising:
a dielectric housing defining a first end face, a second end face in opposite side of said first end face, a tongue board stick out the middle portion of said second end face, a plurality of receiving passages extending onto a side of the tongue board through said first end face and said second end face, a pair of opposite side walls perpendicularly extending out from said second end face, each of said side walls has a top panel perpendicularly extending out from the inner top edge thereof;
a plurality of signal contacts respectively received in said receiving passage of said dielectric housing;
a pair of grounding contacts respectively secured in the housing, one end of each of said grounding contacts exposed for electrically connecting the grounding circuit of a printed circuit board, another end of each of said grounding contacts partially exposed on the lower surface of said top panel for electrically connecting corresponding first contact of a complementary connector.

12. The electrical connector as described in claim 11, wherein a grounding receiving passage defined on the lower surface of each said top panel, said pair of grounding contacts are received in said grounding receiving passage respectively.

13. The electrical connector as described in claim 12, further includes a shield surrounding said dielectric housing.

14. The electrical connector as described in claim 13, wherein said shield is a metal shell stamped and formed of conductive sheet metal material, which is defined by a top wall and a pair of side wall connected with the top wall; a pair of securing means on two opposite side walls for securing the shield on said dielectric housing.

15. The electrical connector as described in claim 14, wherein said shield further defines plurality of fastening tabs project downwardly from the top wall for latching the complementary mating connector.

16. The electrical connector as described in claim 15, wherein said shield further defines four mounting legs on the lower edge of said side walls for electrically connecting to the grounding circuit trace on the printed circuit board and securing the connector on the printed circuit board.

17. The electrical connector as described in claim 16, further defining a mounting surface and two locating post on the mounting surface.

18. An electrical connector assembly comprising:
a first connector having a first insulative housing;
a plurality of first signal contacts with a pair of first grounding contacts by two sides thereof all being disposed in the first housing;
a second connector having a second insulative housing;
a plurality of second signal contacts with a pair of second grounding contacts by two sides thereof all being disposed in the second housing;
mating portions of the first signal contacts being located at different levels with regard to those of the first grounding contacts;
mating portions of the second signal contacts being engaged with those of the corresponding first signals in a direction, mating portions of the second grounding contacts being engaged with those of the corresponding first grounding contacts in a second direction opposite to the first direction.

19. The connector assembly as claimed in claim 18, wherein the mating portions of the first signal contacts and those of the first grounding contacts are essentially of a planar manner while the those of the second signal contacts and of the second grounding contacts are curved with resiliency thereof.

20. The connector assembly as claimed in claim 18, wherein said second signal contacts and said second grounding contacts have respective retention portions for retention with the second housing, and said retention portions of the second signal contacts and those of the second grounding contacts are essentially located at a same level.
